(19) United States
(12) Patent Application Publication
(10) Pub. No.: US 2008/0125188 A1
(43) Pub. Date: May 29, 2008

(54) CELLULAR PHONE CASE CAPABLE OF CHARGING BATTERY BY SOLAR ENERGY

(76) Inventor: JUNG-YEN HUANG, TAIPEI CITY (TW)

Correspondence Address: SINORICA, LLC, 528 FALLSGROVE DRIVE, ROCKVILLE, MD, 20850, US

(21) Appl. No.: 11/941,935

(22) Filed: Nov. 17, 2007

(30) Foreign Application Priority Data
Nov. 23, 2006 (TW) 95220686

(51) Int. Cl. H04M 1/00

(52) U.S. Cl. 455/573

(57) ABSTRACT

A cellular phone case includes a container having a box and a lid to close the opening of the box. A solar cell is provided on the lid to be exposed under sun light. A circuit board is provided in the box and is electrically connected to the solar cell. A battery board is provided in the box and is electrically connected to the circuit board. A socket is provided on the box and is electrically connected to the circuit board to input electricity power into the battery or to output electricity power from the battery.

### BACKGROUND OF THE INVENTION

1. Field of the Invention

The present invention relates generally to a cellular phone case, and more particularly to a cellular phone case capable of charging the battery of the cellular phone by solar energy.

2. Description of the Related Art

Conventional cellular phone cases are only for containing and protecting the cellular phone. People usually mount the cellular phone case on the belt to carry the cellular phone for portable. Battery is the power supply of the cellular phone. When the battery runs out the power, the cellular phone is inoperative. To prevent the battery from running out of power, some user carry additional batteries with him/her, but it is inconvenient to user.

### SUMMARY OF THE INVENTION

The primary objective of the present invention is to provide a cellular phone case, except carry and protect cellular phone, which may charge battery of the cellar phone received in the case to prevent the cellular phone from out of power.

According to the objective of the present invention, a cellular phone case includes a container having a box and a lid to close the opening of the box. A solar cell is provided on the lid to be exposed under sun light. A circuit board is provided in the box and is electrically connected to the solar cell. A battery board is provided in the box and is electrically connected to the circuit board. A socket is provided on the box and is electrically connected to the circuit board to input electricity power into the battery or to output electricity power from the battery.

### BRIEF DESCRIPTION OF THE DRAWINGS

FIG. 1 is a front view of a preferred embodiment of the present invention;

FIG. 2 is a back view of the preferred embodiment of the present invention;

FIG. 3 is a front view of the plug of the cellular phone;

FIG. 4 is a sketch diagram, showing a person carrying the cellular phone case;

FIG. 5 is a sketch diagram, showing how the present invention charges a cellular phone; and

FIG. 6 is a sketch diagram, showing charging the present invention.

### DETAILED DESCRIPTION OF THE INVENTION

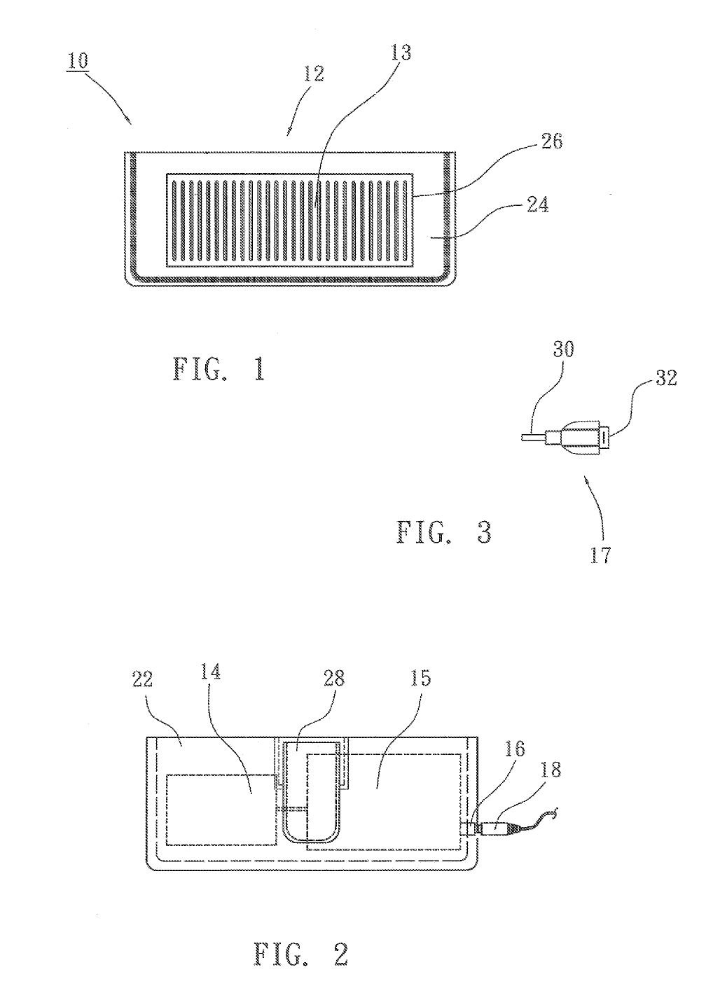

As shown in FIG. 1 to FIG. 3, a cellular phone case 10 of the preferred embodiment of the present invention includes a container 12, a solar cell 13, a circuit board 14, a battery 13, and a socket 16.

The container 12, which is made of leather, has a box 22 with an opening at a top, a lid 24, which has a window 26, having an end connected to a top of a back of the box 22 to close the box 22, and a connection device 28, which is a hook mounted on the back of the box 22.

The solar cell 13, same as a common bulk solar cell, is mounted on an interior side of the lid 24 and behind the window 26 to expose the solar cell 13.

The circuit board 14 is mounted on the box 22 associated with the connection device 28 and electrically connected to the solar cell 13. The circuit board 14 has a circuitry to transmit solar energy to electricity power.

The battery 15, which is a conventional 1200 mA Li-polymer explosion-proof battery, is mounted on the box 22 beside the circuit board 14 and is electrically connected to the circuit board 14.

The socket 16 is the one for cellular phone charging. The socket 16 is mounted on the box 22 and is electrically connected to the circuit board 14.

The present invention further provides various phone connectors 17 (we only show one of which in FIG. 3). The phone connector 17 has a plug 30 at one end and a connection port 32 at opposite. The plug 30 may be connected to a power socket 16. The connection port 32 is various for the specific cellular phone. A phone wire 18 connects the socket 16 and the phone connector 17. Both of the phone connector 17 and the phone wire 18 may be received in the box 22.

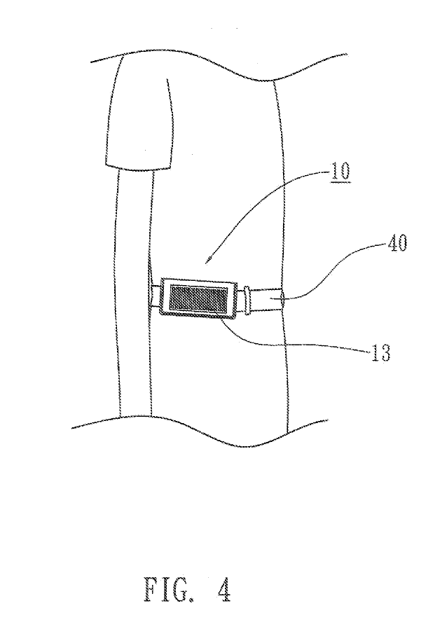

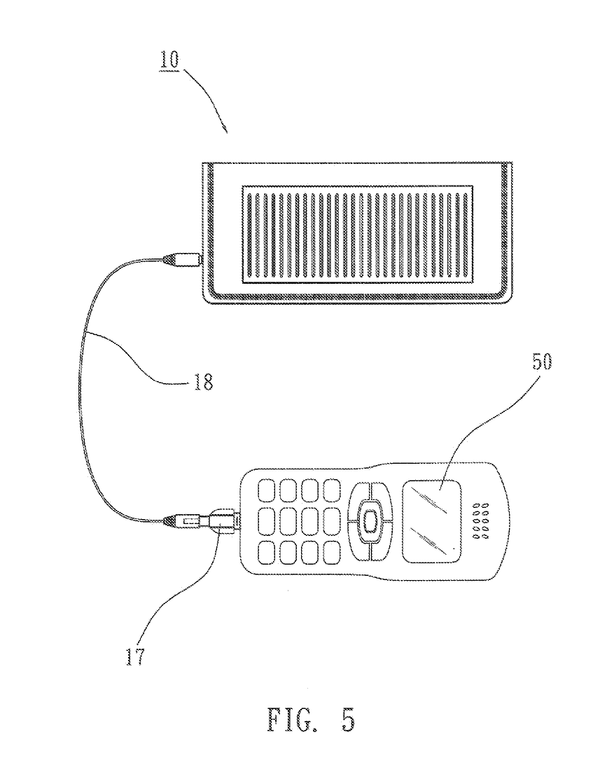

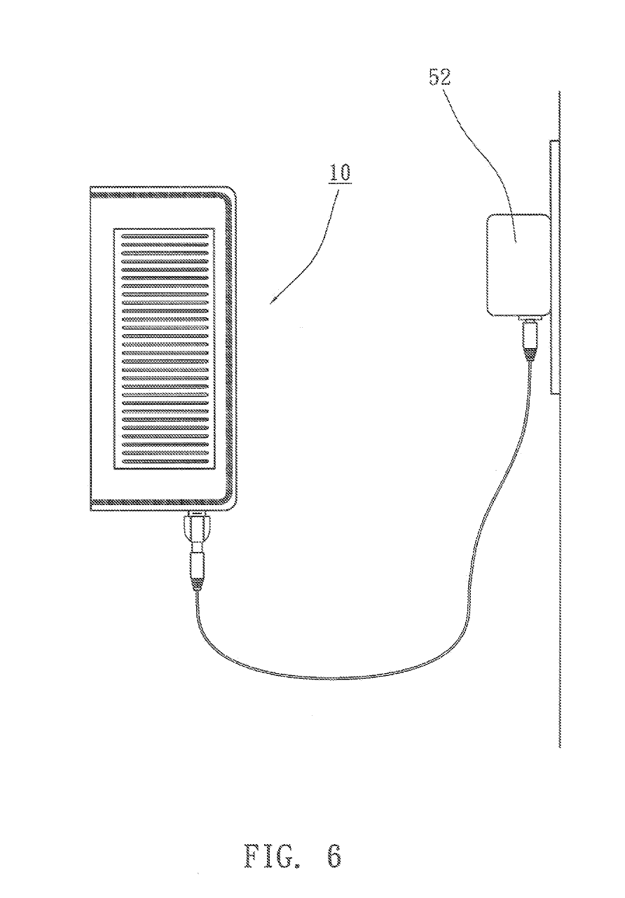

As shown in FIG. 4, the cellular phone case 10 of the present invention may be hung on the belt of a person by the connection device 28. The solar cell 13 is exposed via the window 26 to receive sun light and transmit it to electricity power through the circuit board 14 and store the power in the battery 15. When your cellular phone is about to run out of power, you may connect the phone connector 17 to the phone wire 18, and then connect the phone connector 17 to the cellular phone 50 that the present invention will charge your cellular phone 50, as shown in FIG. 5.

In case of raining days or other conditions without sufficient sun light, as shown in FIG. 6, user may connect a travel charger 52 of the cellular phone 50 to the phone connector 17 that may charge the battery 15.

In conclusion, the cellular phone case of the present invention, except for receiving and protection, may charge the cellular phone received in the case by the solar cell, battery, and circuit board mounted in the case. User has no need to carry additional device to charge your cellular phone whenever and wherever.

What is claimed is:

1. A cellular phone case, comprising:
a container having a box with an opening at a top thereof and a lid connected to the box to close the opening of the box;
a solar cell provided on the lid to be exposed under sun light;
a circuit board provided in the box and electrically connected to the solar cell;
a battery board provided in the box and electrically connected to the circuit board; and
a socket provided on the box and electrically connected to the circuit board to input electricity power into the battery or to output electricity power from the battery.

2. The cellular phone case as defined in claim 1, further comprising various phone connector for different cellular phones, each of which includes a plug at an end thereof to be inserted into the socket and a connection port at the end thereof to be connected to a specific cellular phone.

3. The cellular phone case as defined in claim 2, further comprising a phone wire connecting the socket and the phone connector.

4. The cellular phone case as defined in claim 1, wherein the solar cell is a bulk solar cell.

5. The cellular phone case as defined in claim 1, wherein the battery is a 1200 mA Li-polymer explosion-proof battery.

6. The cellular phone case as defined in claim 1, wherein the lid has a window, and the solar cell is fixed on an interior side of the lid behind the window.

7. The cellular phone case as defined in claim 1, wherein the circuit board has a circuitry to transfer solar power to electricity power.
